(19) United States
(12) Patent Application Publication
(10) Pub. No.: US 2026/0106187 A1
(43) Pub. Date: Apr. 16, 2026

(54) COOLANT DRAIN SYSTEM OF ION FILTER

(71) Applicants: Hyundai Motor Company, Seoul (KR); Kia Corporation, Seoul (KR)

(72) Inventors: Hae Lee LEE, Hwaseong-Si (KR); Dong Nyeok PARK, Hwaseong-Si (KR); Dae Jung KIM, Bucheon-si (KR); Ju Eon CHA, Uiwang-si (KR)

(21) Appl. No.: 19/214,886

(22) Filed: May 21, 2025

(30) Foreign Application Priority Data
Oct. 10, 2024 (KR) 10-2024-0137423

(51) Int. Cl. H01M 8/04029; H01M 8/04537; H01M 8/04746

(52) U.S. Cl. CPC H01M 8/04029; H01M 8/04649; H01M 8/04768; H01M 2250/20

(57) ABSTRACT

A coolant drain system of an ion filter may prevent deterioration in filtration performance of an ion exchange resin and improve durability thereof. The coolant drain system is operated in such that, when electrical conductivity of coolant circulating through a fuel cell stack is equal to or higher than a predetermined level, the coolant circulates through the inside of the ion filter such that metal ions of the coolant are easily removed by the ion exchange resin. When electrical conductivity of the coolant is reduced to be lower than the predetermined level, the coolant remaining inside the ion filter is drained to a pressurized reservoir using the pressure of air supplied from the pressurized reservoir.

### CROSS-REFERENCE TO RELATED APPLICATION

This application claims, under 35 U.S.C. § 119(a), the benefit of priority from Korean Patent Application No. 10-2024-0137423, filed on Oct. 10, 2024, the entire contents of which are incorporated herein by reference.

### TECHNICAL FIELD

The present disclosure relates to a coolant drain system of an ion filter, and more particularly, to a coolant drain system of an ion filter configured to secure durability of the ion filter by draining coolant contained in the ion filter when insulation resistance of a fuel cell stack is restored.

### BACKGROUND

A fuel cell stack mounted in a hydrogen fuel cell electric vehicle generates electric energy via/an electrochemical reaction between hydrogen and oxygen, each serving as reactive gases. Since heat energy is released as a reaction byproduct, it may be required to appropriately cool the fuel cell stack.

A cooling method of allowing coolant to circulate through/around the fuel cell stack may be used.

FIG. 1 is a schematic diagram showing an example coolant circulation loop of a fuel cell stack.

As shown in FIG. 1, a fuel cell stack 10, a radiator 20, and a pump 30 are connected to each other by a coolant circulation line 40, and coolant circulates along the coolant circulation line, thereby allowing the coolant to circulate through the fuel cell stack 10, the radiator 20, and the pump 30.

A first control valve 41 is mounted on the coolant circulation line 40 between a coolant outlet port of the pump 30 and a coolant inlet port of the fuel cell stack 10, and a second control valve 42 is mounted on the coolant circulation line 40 between a coolant outlet port of the radiator 20 and a coolant inlet port of the pump 30.

The first control valve 41, an ion filter 50, and the second control valve 42 are connected to each other by a coolant branch line 60, and coolant circulates along the coolant branch line, thereby allowing the coolant to circulate through the first control valve 41, the ion filter 50, and the second control valve 42.

Each of the first control valve 41 and the second control valve 42 may be formed as an electric three-way valve, the opening degree of which may be controllable by a controller (e.g., computing device/signal generator).

The ion filter 50 serves to remove metal ions from the coolant (e.g., that has circulated through the fuel cell stack).

When/if electrical conductivity of coolant circulating through the fuel cell stack is above a predetermined level, insulation stability of the fuel cell stack may deteriorate, which may cause a short circuit. To avoid/reduce a possibility of damage to the fuel cell stack, the ion filter 50 serves to control electrical conductivity, which increases by the metal ions present in the coolant (e.g., that build up over time with repeated circulation) such that electrical conductivity is adjusted to be lower than the predetermined level, thereby increasing/maintaining insulation stability of the fuel cell stack (e.g., restoring insulation resistance of the fuel cell stack).

The ion filter 50 may have a fine particle ion exchange resin configured to substantially filter ions from coolant. Coolant that has circulated through the fuel cell stack enters the ion filter 50, and metal ions from the coolant are removed by the ion exchange resin inside the ion filter. Thereafter, the coolant circulates back to the fuel cell stack 10. In this manner, the concentration of ions in the stack coolant (e.g., and therefore electrical conductivity), may be adjusted to be lower (e.g., than the predetermined level).

In a coolant circulation loop of the fuel cell stack configured as described above, coolant circulates along the coolant circulation line 40 while sequentially passing through the fuel cell stack 10 and the radiator 20 by driving of the pump 30, thereby reliably cooling the fuel cell stack 10.

At this time, electrical conductivity of the coolant circulating along the coolant circulation line 40 may be detected by a conductivity sensor (not shown), and a detected signal may be transmitted to a controller (not shown).

The controller may determine whether electrical conductivity of the coolant is equal to or higher than a predetermined level (e.g., such that insulation resistance of the fuel cell stack needs to be restored). The controller may control the first control valve 41 to be opened not only toward the coolant inlet port of the fuel cell stack 10 but also toward the ion filter 50. The controller may also control the second control valve 42 to be opened toward the coolant inlet port of the pump 30. As such, a part of the coolant may pass through the ion filter 50, to circulate along the coolant branch line 60, and to circulate again along the coolant circulation line 40.

Here, the metal ions from the coolant are removed by the ion exchange resin filling the inside of the ion filter 50. In this manner, electrical conductivity of the coolant may be controlled to be lower than a predetermined level (e.g., such that insulation resistance of the fuel cell stack may be restored).

The coolant may comprise a mixture of water and ethylene glycol (EG). When/if the coolant passes through the ion exchange resin and/or comes into contact with the ion exchange resin, the ion exchange resin acts as an oxidation catalyst for the coolant. With oxidation of the coolant, release of anions from the coolant increases, leading to an increase in ion filtration load (ion removal load) of the ion exchange resin. Accordingly, filtration performance of the ion exchange resin may deteriorate, and the lifespan of the ion exchange resin may be shortened.

While a fuel cell vehicle is driving, and/or when a fuel cell vehicle is parked and/or stopped, the coolant stagnates in the ion filter and, as such, the coolant and the ion exchange resin are constantly/statically in contact with each other. Accordingly, oxidation of the coolant stagnant in the ion filter is further promoted, and the release of anions from the coolant continues, which may lead to a further increase in ion filtration load of the ion exchange resin. As a result, filtration performance of the ion exchange resin may deteriorate, and the lifespan of the ion exchange resin may be shortened.

The above information disclosed in this Background section is only for enhancement of understanding of the background of the disclosure, and therefore it may contain information that does not form the prior art that is already known in this country to a person of ordinary skill in the art.

### SUMMARY

The following summary presents a simplified summary of certain features. The summary is not an extensive overview and is not intended to identify key or critical elements.

Systems, apparatuses, and methods are described for a coolant drain system of an ion filter. A coolant drain system may comprise: a coolant circulation line configured to allow coolant to circulate through a fuel cell stack, a radiator, and a pump; a first control valve mounted on the coolant circulation line between a coolant outlet port of the pump and a coolant inlet port of the fuel cell stack; a second control valve mounted on the coolant circulation line between a coolant outlet port of the radiator and a coolant inlet port of the pump; a coolant branch line configured to allow the coolant to circulate through the first control valve, an ion filter, and the second control valve; a pressurized reservoir mounted on the coolant branch line between a coolant outlet port of the ion filter and the second control valve; an air supply line configured to supply air from the pressurized reservoir to an inside of the ion filter; and a controller configured to control: a first opening/closing direction of the first control valve; and a second opening/closing direction of the second control valve.

Also, or alternatively, a coolant drain system may comprise: a coolant circulation line configured to allow coolant to circulate through a fuel cell stack, a radiator, and a pump; a first control valve mounted on the coolant circulation line between a coolant outlet port of the pump and a coolant inlet port of the fuel cell stack; a second control valve mounted on the coolant circulation line between a coolant outlet port of the radiator and a coolant inlet port of the pump; a coolant branch line configured to allow the coolant to circulate through the first control valve, an ion filter, and the second control valve; a pressurized reservoir mounted on the coolant branch line between the ion filter and the second control valve; a first air flow connector formed on the pressurized reservoir; a second air flow connector formed on the ion filter, wherein the first air flow connector and the second air flow connector are connected to each other to allow the pressurized reservoir to supply air to an inside of the ion filter; a first coolant flow connector formed on the ion filter; a second coolant flow connector formed on the pressurized reservoir, wherein the first coolant flow connector and the second coolant flow connector are connected to each other to allow the coolant to flow from the ion filter to the pressurized reservoir; and a controller configured to control: a first opening/closing direction ; of the first control valve; and a second opening/closing direction of the second control valve.

Also, or alternatively, a coolant drain system may comprise: a coolant circulation line configured to allow coolant to circulate to exchange heat with a fuel cell stack, a radiator, and a pump; a first control valve mounted on the coolant circulation line between the pump and the fuel cell stack; a second control valve mounted on the coolant circulation line between the radiator and the pump; a coolant branch line configured to allow the coolant to circulate through the first control valve, an ion filter, and the second control valve; a pressurized reservoir mounted on the coolant branch line between a coolant outlet port of the ion filter and the second control valve and configured to supply air to an inside of the ion filter; a conductivity sensor configured to measure a conductivity of the coolant; and a controller configured to control, based on the conductivity: the first control valve; the second control valve; and supply of air from the pressurized reservoir.

These and other features and advantages are described in greater detail below.

### BRIEF DESCRIPTION OF THE DRAWINGS

The above and other features of the present disclosure will now be described in detail with reference to certain examples thereof illustrated in the accompanying drawings which are given hereinbelow by way of illustration only, and thus are not limitative of the present disclosure, and wherein:

FIG. 1 is a schematic diagram showing an example coolant circulation loop of a fuel cell stack;

FIG. 2 is a configuration diagram showing a coolant drain system of an ion filter;

FIG. 3 is a perspective view of the ion filter;

FIG. 4 is a cross-sectional view of the ion filter;

FIG. 5 is a perspective view showing a connection state between the ion filter and a pressurized reservoir according to an example of the present disclosure;

FIG. 6 is an enlarged schematic diagram showing a state in which a coolant discharge hose and a coolant drain pipe shown in FIG. 5 are connected to each other by a joint pipe;

FIG. 7 is a schematic diagram showing a state in which a solenoid valve is mounted on an air supply line connecting the ion filter to the pressurized reservoir according to the example of the present disclosure;

FIG. 8 is a front view of an ion filter according to an example of the present disclosure;

FIG. 9 is a front view of a pressurized reservoir according to an example of the present disclosure; and

FIG. 10 is a perspective view showing a connection state between the ion filter and the pressurized reservoir according to an example of the present disclosure.

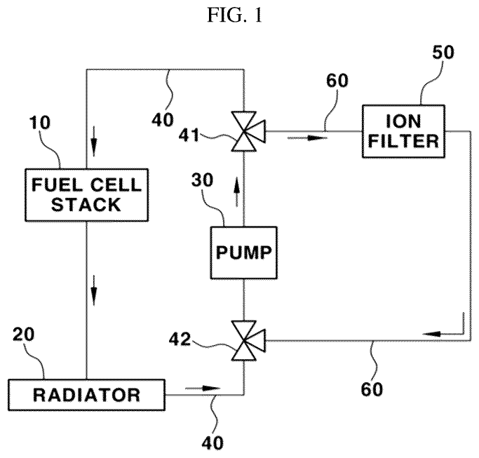

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various examples of the present disclosure, illustrated in the accompanying drawings and described below. Specific structural or functional descriptions given in connection with the examples of the present disclosure are merely illustrative for the purpose of describing examples according to the concept of the present disclosure, and the examples according to the concept of the present disclosure may be implemented in various forms. Further, it will be understood that the present description is not intended to limit the disclosure to the examples. On the contrary, the disclosure is intended to cover not only the examples, but also various alternatives, modifications, equivalents, and other examples, which may be included within the spirit and scope of the disclosure as defined by the appended claims.

In the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, that is, “between” and “directly between” or “adjacent to” and “directly adjacent to”, should be interpreted in the same manner.

The same reference numerals represent the same components throughout the specification. Additionally, the terms in the specification are used merely to describe examples and are not intended to limit the present disclosure. In this specification, an expression in a singular form also includes a plural form, unless clearly specified otherwise in context. As used herein, expressions such as “comprise” and/or “comprising” do not exclude the presence or addition of one or more components, steps, operations, and/or elements other than those described.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. The phrase “one or more of”may be used interchangeably with “at least one of”.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

A controller may include a communication/computing device configured for communicating with other controllers and/or one or more sensors to control one or more functions and/or operations in charge, a memory storing an operation system, a logic command, and/or input/output information, and/or one or more processors performing determination, calculation, and/or decision/determinations necessary for controlling the function in charge. A controller may include, for example, a processor, a central processing unit (CPU), a microchip, a logic, an application-specific integrated circuit (ASIC), memory, etc. A controller may manipulate and/or control other components in the system (e.g., vehicle).

It is understood that the terms “vehicle”, “vehicular”, and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

Hereinafter, examples of the present disclosure will be described in detail with reference to the accompanying drawings.

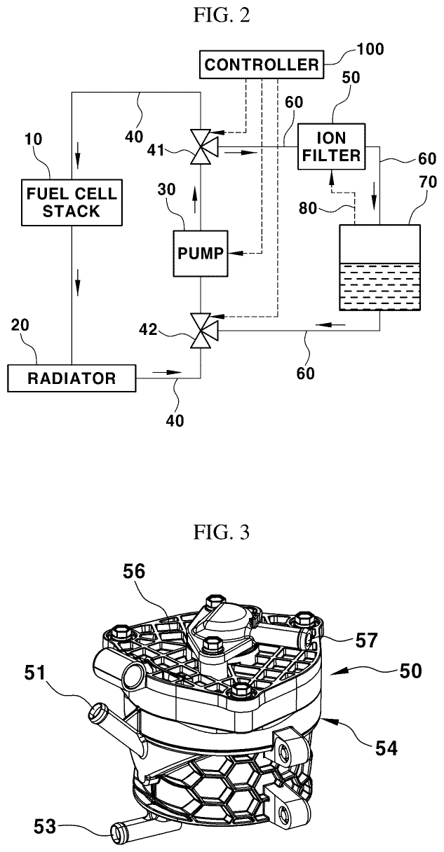

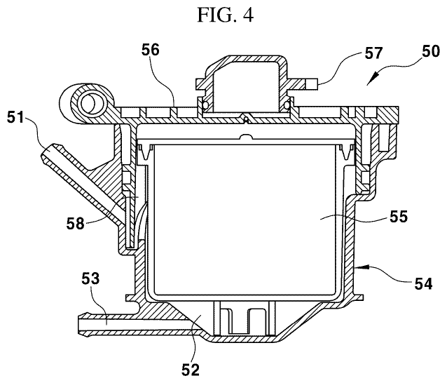

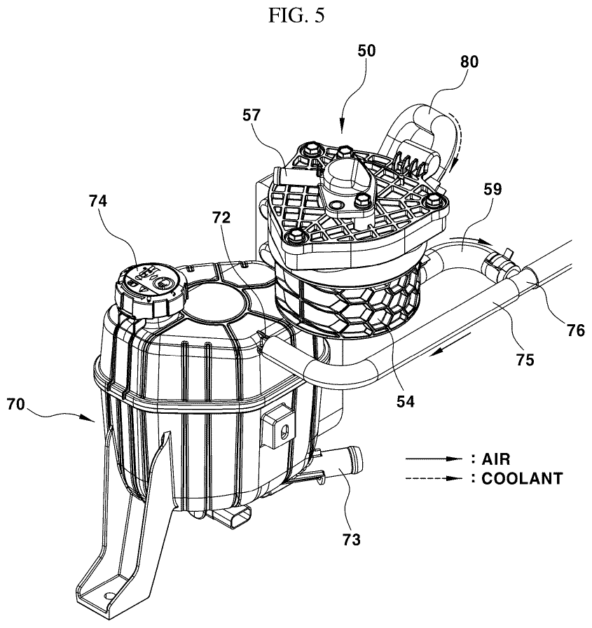

FIG. 2 is a configuration diagram showing a coolant drain system of an ion filter, FIGS. 3 and 4 are diagrams each showing the ion filter, and FIG. 5 is a perspective view showing a connection state between the ion filter and a pressurized reservoir according to an example of the present disclosure.

As shown in FIG. 2, a fuel cell stack 10, a radiator 20, and a pump 30 may be connected to each other by a coolant circulation line 40. Coolant may circulate along the coolant circulation line, thereby allowing the coolant to circulate through/around the fuel cell stack 10, the radiator 20, and the pump 30.

A first control valve 41 may be connected to (e.g., mounted on) the coolant circulation line 40 between a coolant outlet port of the pump 30 and a coolant inlet port of the fuel cell stack 10. A second control valve 42 may be connected to (e.g., mounted on) the coolant circulation line 40 between a coolant outlet port of the radiator 20 and a coolant inlet port of the pump 30.

The first control valve 41, an ion filter 50, a pressurized reservoir 70, and the second control valve 42 may be connected to each other by a coolant branch line 60. Coolant may circulate along the coolant branch line 60, thereby allowing the coolant to circulate through/around the first control valve 41, the ion filter 50, the pressurized reservoir 70, and the second control valve 42.

Each of the first control valve 41 and the second control valve 42 may be formed as three-way valve (e.g., an electric three-way valve). An opening/closing direction and/or an opening degree of each of the first control valve 41 and the second control valve 42 may be controlled by one or more control signals from a controller 100.

The ion filter 50 may serve to remove metal ions from the coolant (e.g., the coolant that that has circulated through the fuel cell stack).

FIGS. 3 and 4 show detailed internal and external views of an example ion filter 50. The ion filter 50 has a fine particle ion exchange resin 55 built/contained therein. The ion exchange resin 55 may be configured to substantially filter ions (e.g., contained in the coolant). Coolant that has circulated through the fuel cell stack may enter the ion filter 50, and metal ions from the coolant may be removed by the ion exchange resin 55 inside the ion filter 50. Thereafter, the coolant may circulate back to the fuel cell stack 10. In this manner, the concentration of ions in the stack coolant (e.g., corresponding to electrical conductivity) may be adjusted to satisfy a threshold (e.g., to be lower than a predetermined level corresponding to an undesirable electrical conductivity). Accordingly, insulation resistance of the fuel cell stack may be restored (e.g., at an acceptably low level).

FIG. 2 shows the pressurized reservoir 70 mounted on the coolant branch line 60 between a coolant outlet port of the ion filter 50 and the second control valve 42. An air supply line 80 may connect the pressurized reservoir 70 to the ion filter 50 (e.g., such that air may be supplied from the pressurized reservoir 70 to the inside of the ion filter 50).

The pressurized reservoir 70 may be configured to be closed with a pressure control cap 74 (e.g., mounted on an upper portion of the pressurized reservoir 70 in FIG. 5). The pressure control cap 74 may be operated/used to allow/cause the internal pressure of the reservoir 70 to be controlled (e.g., to be higher than an external pressure of the reservoir 70).

The ion filter 50 may include a housing 54 (see, e.g., FIGS. 3-5). The housing 54 may have an air inlet port 51 (e.g., formed at an upper portion of the housing 54). The air inlet port 51 may be connected to the other end of the air supply line 80. A coolant stagnation space 52 may be formed in an portion of the housing 54 away from the air inlet port 51 (e.g., in an inner bottom portion of the housing relative to the air inlet port 51). A coolant outlet port 53 may be formed at a lower portion of the housing 54. The coolant outlet port 54 may be configured to communicate with the coolant stagnation space 52.

The housing 54 may include the ion exchange resin 55 inside the housing 54 and configured to filter metal ions from the coolant.

A cap 56 may be coupled/couplable to an upper opening of the housing 54. A coolant inlet port 57 configured to allow coolant to be introduced into the housing 54 may be formed on the upper surface of the cap 56.

An air flow passage 58 may be configured to communicate with the air inlet port 51. The air flow passage 58 may be formed between an inner surface of the housing 54 and an outer surface of the ion exchange resin 55.

According to the example of the present disclosure, as shown in FIGS. 5 and 7, the pressurized reservoir 70 may be provided with a structure including a degassing port 71 formed at one upper portion of the pressurized reservoir and connected to one end of the air supply line 80, a coolant drain port 72 formed at the other upper portion of the pressurized reservoir and communicatively connected to the coolant outlet port 53 formed at the housing 54 of the ion filter 50, and a coolant circulation port 73 formed at a lower portion of the pressurized reservoir and configured to circulate the coolant toward the second control valve 42.

The ion filter 50 may be disposed at a higher position than a position of the pressurized reservoir 70 (e.g., when installed in a vehicle comprising the fuel cell) such that the coolant remaining inside the housing 54 of the ion filter 50 may be easily discharged to the pressurized reservoir 70.

The ion filter 50 being disposed at a higher position than a position of the pressurized reservoir 70 may allow for the ion filter 50 and the pressurized reservoir 70 to be connected to each other so as to allow the coolant to flow therebetween.

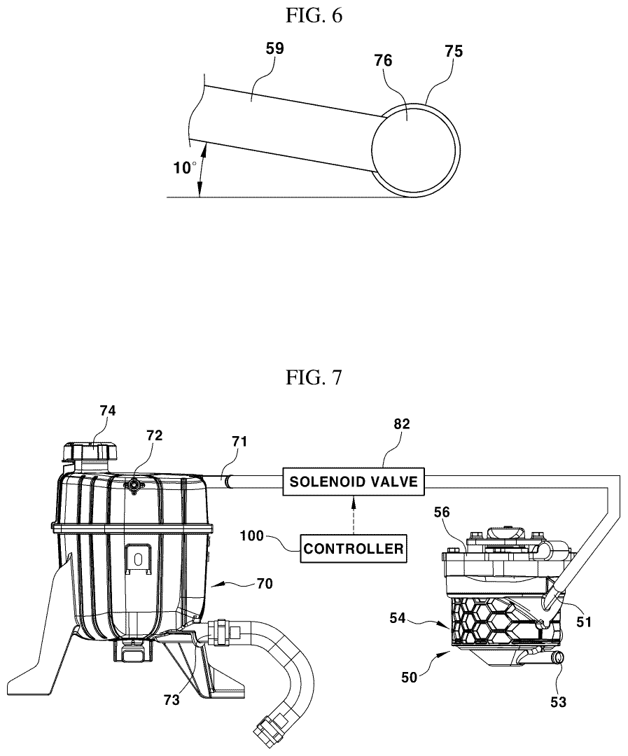

To this end, as shown in FIGS. 5 and 6, a coolant discharge hose 59 may be connected to the coolant outlet port 53 formed in the housing 54 of the ion filter 50. A coolant drain pipe 75 communicatively connected to the coolant discharge hose 59 may be connected to the coolant drain port 72 of the pressurized reservoir 70.

The coolant discharge hose 59 and the coolant drain pipe 75 may be communicatively connected to each other by a joint pipe 76 configured to arrange the coolant discharge hose 59 to be inclined downwards toward the coolant drain pipe 75, thereby allowing the coolant to be easily drained from the housing 54 of the ion filter 50 to the pressurized reservoir 70.

The air supply line 80 may have a solenoid valve 82 mounted thereon. The solenoid valve 82 may be configured to be turned on or off in response to a control signal from the controller 100 so as to permit or block a supply of air from the pressurized reservoir 70 to the inside of the ion filter 50 (e.g., to the inside of the housing 54).

If the solenoid valve 82 is turned on (e.g., in response to the control signal from the controller 100), air filling/from the upper space of the pressurized reservoir 70 may be supplied into the housing 54 of the ion filter 50 (e.g., along/via the air supply line 80). The coolant contained in the ion exchange resin 55 may be separated from the ion exchange resin by pressure of the air supplied into the housing 54. The coolant separated from the ion exchange resin 55 may be collected in the coolant stagnation space 52 (e.g., disposed in the inner bottom of the housing 54).

If the solenoid valve 82 is turned off (e.g., in response to the control signal from the controller 100), the supply of air into the housing 54 may be blocked. The coolant may substantively remain in contact with the ion exchange resin 55, and metal ions of the coolant may be removed by the ion exchange resin 55 while the coolant is in contact with the ion exchange resin 55.

An operation flow of the coolant drain system of the present disclosure, based on the configuration described herein, will be described below.

When/if the pump 30 is driven, coolant may circulate along the coolant circulation line 40 to pass through the fuel cell stack 10 and the radiator 20, thereby making it possible to cool the fuel cell stack 10.

Electrical conductivity of the coolant circulating along the coolant circulation line 40 may be detected by a conductivity sensor (not shown). A detected signal (e.g., indicated detected conductivity) may be transmitted to the controller 100.

When/if electrical conductivity of the coolant satisfies a threshold for adjustment (e.g., is equal to or higher a predetermined level), the controller 100 may be configured to determine that insulation resistance of the fuel cell stack needs to be restored. The controller 100 may be configured to, based on determining the electrical conductivity satisfies the threshold, control the first control valve 41 to be opened toward the ion filter 50 (e.g., at least partially, in addition to toward the coolant inlet port of the fuel cell stack 10). The controller 100 may be configured to, based on determining the electrical conductivity satisfies the threshold, to control the second control valve 42 to be opened toward the coolant inlet port of the pump 30. At least a part of the coolant may pass through the ion filter 50, pass through the pressurized reservoir 70, circulate along the coolant branch line 60, and/or circulates along the coolant circulation line 40.

Since metal ions of the coolant are removed by the ion exchange resin 55 filling the inside of the ion filter 50, electrical conductivity of the coolant may be adjusted to no longer satisfy the threshold for adjustment (e.g., to be lower than the predetermined level). The predetermined level may be a conductivity at and/or below which insulation resistance of the fuel cell stack is considered restored.

When/if the coolant passes through the ion exchange resin 55 (e.g., comes into contact with the ion exchange resin 55), the ion exchange resin 55 may acts as an oxidation catalyst for the coolant. Promoting oxidation of the coolant may increase the release of anions from the coolant. Released anions may lead to an increase in ion filtration load (ion removal load) of the ion exchange resin 55. Filtration performance of the ion exchange resin may deteriorate, and the lifespan of the ion exchange resin may be shortened.

While/if a fuel cell vehicle is driving, and/or when/if a fuel cell vehicle is parked and/or stopped, the coolant may stagnate in the ion exchange resin 55 of the ion filter 50. As the coolant and the ion exchange resin 55 remain in contact with each other, oxidation of the coolant may be further promoted, such that the release of anions from the coolant continues to increase. This may lead to a further increase in ion filtration load of the ion exchange resin 55. Filtration performance of the ion exchange resin may further deteriorate, and the lifespan of the ion exchange resin may be further shortened.

When/if insulation resistance of the fuel cell stack is determined sufficient (e.g., the electrical conductivity does not satisfy the threshold for adjustment, the insulation resistance is restored), the controller 100 may perform a control operation (e.g., send a first control signal) to close the first control valve 41. Closing the first control valve 41 may prevent the coolant from flowing into the ion filter 50. The controller 100 may perform a control operation (e.g., send a second control signal) to turn on (e.g., open) the solenoid valve 82 mounted on the air supply line 80.

When/if the first control valve 41 is closed, the coolant may be blocked from flowing into the ion filter 50, and air inside the pressurized reservoir 70 may be supplied to the inside of the housing 54 of the ion filter 50 via the air supply line 80. Air pressure (e.g., from supply of the air from the pressurized reservoir 70 to the inside of the housing 54) may be applied to the coolant remaining in the ion exchange resin 55 of the ion filter 50. The coolant may be separated from the ion exchange resin 55 (e.g., by the air pressure) and collected in the coolant stagnation space 52 disposed in the inner bottom of the housing 54. The collected coolant may be drained to the pressurized reservoir 70.

When/if the air in the pressurized reservoir 70 is supplied to the inside of the housing 54 of the ion filter 50 (e.g., via the air supply line 80), the air may flow through the air flow passage 58 between the inner surface of the housing 54 and the outer surface of the ion exchange resin 55. The air flow may provide air pressure on the coolant remaining in the ion exchange resin 55 of the ion filter 50, thereby separating/facilitating separation of the coolant from the ion exchange resin 55. The coolant may be collected in the coolant stagnation space 52 disposed in the inner bottom of the housing 54. The coolant may be easily drained to the pressurized reservoir 70 via the coolant discharge hose 59 and/or the coolant drain pipe 75.

According to the example of the present disclosure, the coolant remaining in the ion exchange resin 55 of the ion filter 50 may be drained to the pressurized reservoir 70 using/facilitated by the pressure of air supplied from the pressurized reservoir 70. Draining/encouraging draining of the coolant may reduce (e.g., maximally reduce) direct contact between the coolant and the ion exchange resin 55, and reduce (e.g., maximally reduce) a role of the ion exchange resin 55 as an oxidation catalyst for the coolant. Reducing direct contact prevents deterioration in durability of the ion exchange resin and reliably improves the lifespan of the ion exchange resin.

A coolant drain system according to an example of the present disclosure will be described below.

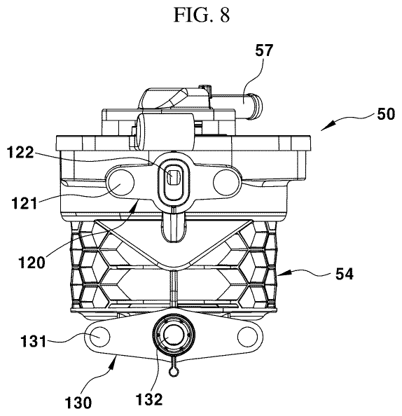

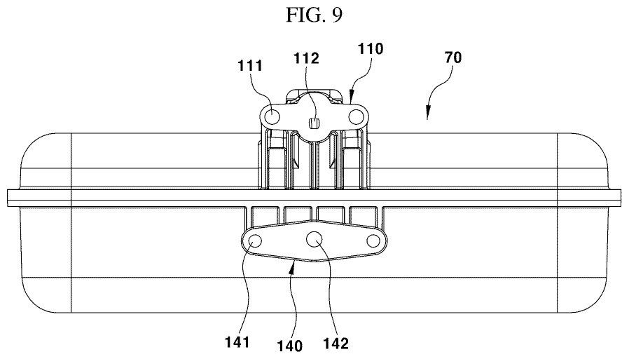

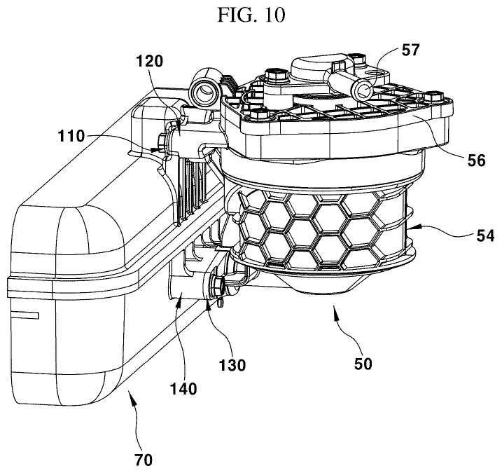

FIG. 8 is a front view of an ion filter according to an example of the present disclosure, FIG. 9 is a front view of a pressurized reservoir according to an example of the present disclosure, and FIG. 10 is a perspective view showing a connection state between the ion filter and the pressurized reservoir according to an example of the present disclosure.

The other example(s) of the present disclosure is configured in the same manner as the coolant drain system of the above-described example, and is characterized by a structural configuration in which the ion filter 50 and the pressurized reservoir 70 are directly connected to each other, thereby allowing air and coolant to flow therebetween.

In the previously discussed example, the ion filter 50 and the pressurized reservoir 70 may be connected to each other by the air supply line 80, allowing air to flow therebetween. The ion filter 50 and the pressurized reservoir 70 may be connected to each other by the coolant discharge hose 59 and/or the coolant drain pipe 75, thereby allowing coolant to flow therebetween. In the other example of the present disclosure, the ion filter 50 and the pressurized reservoir 70 may be directly connected to each other to allowing air and coolant to flow therebetween.

A first air flow connector 110 and/or a second air flow connector 120 may be respectively formed on the pressurized reservoir 70 and the housing 54 of the ion filter 50. The first air flow connector 110 and the second air flow connector 120 may be (e.g., configured to be) connected to each other so as to supply air from the pressurized reservoir 70 to the inside of the housing 54 of the ion filter 50.

A first coolant flow connector 130 and a second coolant flow connector 140 may be respectively formed on the housing 54 of the ion filter 50 and the pressurized reservoir 70. The first coolant flow connector 130 and the second coolant flow connector 140 may be (e.g., configured to be) connected to each other so as to allow coolant to flow from the housing 54 of the ion filter 50 to the pressurized reservoir 70.

The housing 54 of the ion filter 50 may be provided with a structural configuration in which, as shown in FIG. 8, the second air flow connector 120 is formed at an upper portion of the housing 54, a coolant stagnation space is formed in the inner bottom portion of the housing 54. The first coolant flow connector 130 may be formed at a lower portion of the housing and communicates with the coolant stagnation space.

As described herein, the inside of the housing 54 may be filled with the ion exchange resin 55, the cap 56 having the coolant inlet port 57 may be coupled to the upper opening of the housing 54, and the air flow passage 58 may be formed between the inner surface of the housing 54 and the outer surface of the ion exchange resin 55.

For example, the second air flow connector 120 formed at the housing 54 of the ion filter 50 may have one or more bolt fastening grooves 121 (e.g. such as bolt fastening grooves 121 respectively formed in opposite ends of the second air flow connector 120). An air inlet hole 122 may be formed in the second air flow connector 120, for example, between the bolt fastening grooves 121.

For example, the first coolant flow connector 130 formed at the housing 54 of the ion filter 50 may have one or more bolt fastening holes 131 (e.g., such as bold fastening holes 131 respectively formed in the opposite ends of the first coolant flow connector 130). A coolant outlet hole 132 may be formed in the first coolant flow connector 130, for example, between the bolt fastening holes 131.

As shown in FIG. 9, the pressurized reservoir 70 may be provided with a structural configuration in which the first air flow connector 110 is formed at one upper portion of the pressurized reservoir, and the second coolant flow connector 140 is formed at one lower portion of the pressurized reservoir.

For example, the first air flow connector 110 formed at the pressurized reservoir 70 may have one or more bolt fastening holes 111 (e.g., bolt fastening holes 111 respectively formed in the opposite ends of the first air flow connector 110). An air supply hole 112 may be formed in the first air flow connector 110, for example, between the bolt fastening holes 111.

For example, the second coolant flow connector 140 formed at the pressurized reservoir 70 may have one or more bolt fastening grooves 141 (e.g., bolt fastening grooves 141 respectively formed in the opposite ends second coolant flow connector). A coolant drain hole 142 may be formed in the second coolant flor connector 140, for example, between the bolt fastening grooves 141.

Accordingly, the bolt fastening holes 111 of the first air flow connector 110 and the bolt fastening grooves 121 of the second air flow connector 120 may be configured to be brought into close contact with each other, such that bolts can be respectively fastened through the bolt fastening holes 111 to the bolt fastening grooves 121. In this manner, as shown in FIG. 10, the first air flow connector 110 and the second air flow connector 120 may be fastened to each other, such that the air supply hole 112 and the air inlet hole 122 may communicate with each other.

The bolt fastening holes 131 of the first coolant flow connector 130 and the bolt fastening grooves 141 of the second coolant flow connector 140 are brought into close contact with each other, such that bolts can be respectively fastened through the bolt fastening holes 131 to the bolt fastening grooves 141. As shown in FIG. 10, for example, the first coolant flow connector 130 and the second coolant flow connector 140 may be fastened to each other such that the coolant outlet hole 132 and the coolant drain hole 142 may communicate with each other.

The controller 100 may determines that electrical conductivity of the coolant satisfies a threshold for adjustment (e.g., is equal to or higher than a predetermined level), such that insulation resistance of the fuel cell stack should be restored. Based on the determining, the controller 100 may control the first control valve 41 to be opened toward the coolant inlet port of the fuel cell stack 10 and also toward the ion filter 50. Also, based on this determining, the controller 100 may control the second control valve 42 to be opened toward the coolant inlet port of the pump 30. At least a part of the coolant may pass through the first coolant flow connector 130 of the ion filter 50 and the second coolant flow connector 140 of the pressurized reservoir 70 and flow into the pressurized reservoir 70. The coolant may pass through the coolant branch line 60 from the pressurized reservoir 70 and then circulates along the coolant circulation line 40 again.

Metal ions of the coolant may be removed by the ion exchange resin 55 inside of the ion filter 50 (e.g., filling the ion filter 50 at least partially). Electrical conductivity of the coolant may be controlled to no longer satisfy the threshold for adjustment (e.g., to be lower than a predetermined level at and/or below which insulation resistance of the fuel cell stack may be restored). For example, electrical conductivity of the coolant may be monitored (e.g., by a conductivity sensor and/or the controller 100 obtaining readings/signals from a conductivity sensor).

Based on determining the electrical conductivity of the coolant not satisfying the threshold for adjustment (e.g., satisfying a threshold for sufficiently low electrical conductivity, such as being less than the predetermined value, such that insulation resistance of the fuel cell stack is restored), the controller 100 may perform a control operation (e.g., send a control signal) to close the first control valve 41, such that the coolant is prevented from flowing into the ion filter 50.

When/if the first control valve 41 is closed, the coolant is blocked from flowing into the ion filter 50, and air inside the pressurized reservoir 70 is supplied to the inside of the housing 54 of the ion filter 50 through the air supply hole 112 of the first air flow connector 110 and the air inlet hole 122 of the second air flow connector 120. Air pressure is applied to the coolant remaining in the ion exchange resin 55 of the ion filter 50. The air pressure may the coolant be separated from the ion exchange resin 55, for example, facilitated by the air pressure. The separated coolant may be collected in the coolant stagnation space 52 disposed in the inner bottom of the housing 54. The collected coolant may be drained to the pressurized reservoir 70.

The coolant may be collected in the coolant stagnation space 52 disposed in the inner bottom of the housing 54. The collected coolant may be easily drained into the pressurized reservoir 70 via the coolant outlet hole 132 of the first coolant flow connector 130 and the coolant drain hole 142 of the second coolant flow connector 140.

According to another example of the present disclosure, the coolant remaining in the ion exchange resin 55 of the ion filter 50 may be drained into the pressurized reservoir 70 using/facilitated by the pressure of air supplied from the pressurized reservoir 70. Draining/encouraging draining of the coolant may reduce (e.g., maximally reduce) direct contact between the coolant and the ion exchange resin 55, and reduce (e.g., maximally reduce) a role of the ion exchange resin 55 as an oxidation catalyst for the coolant. Reducing direct contact prevents deterioration in durability of the ion exchange resin and reliably improves the lifespan of the ion exchange resin.

The present disclosure has been made in an effort to solve problems associated with at least one implementation. It is an object of the present disclosure to provide a coolant drain system of an ion filter capable of preventing deterioration in filtration performance of an ion exchange resin and improving durability of the ion exchange resin, wherein the coolant drain system is operated in such a manner that, when electrical conductivity of coolant circulating through a fuel cell stack is equal to or higher than a predetermined level, that is, when insulation resistance of the fuel cell stack needs to be restored, the coolant circulates through the inside of the ion filter such that metal ions of the coolant are easily removed by the ion exchange resin filling the inside of the ion filter, whereas when electrical conductivity of the coolant is reduced to be lower than the predetermined level, that is, when insulation resistance of the fuel cell stack is restored, the coolant remaining inside the ion filter may be drained to a pressurized reservoir using the pressure of air supplied from the pressurized reservoir.

The present disclosure provides a coolant drain system of an ion filter, the coolant drain system including a coolant circulation line configured to connect a fuel cell stack, a radiator, and a pump to each other so as to allow coolant to circulate through the fuel cell stack, the radiator, and the pump, a first control valve mounted on the coolant circulation line between a coolant outlet port of the pump and a coolant inlet port of the fuel cell stack, a second control valve mounted on the coolant circulation line between a coolant outlet port of the radiator and a coolant inlet port of the pump, a coolant branch line configured to connect the first control valve, the ion filter, and the second control valve so as to allow the coolant to circulate through the first control valve, the ion filter, and the second control valve, a pressurized reservoir mounted on the coolant branch line between a coolant outlet port of the ion filter and the second control valve, an air supply line configured to connect the pressurized reservoir to the ion filter such that air is supplied from the pressurized reservoir to an inside of the ion filter, and a controller configured to control an opening/closing direction and an opening degree of each of the first control valve and the second control valve.

For example, the ion filter may be disposed at a higher position than a position of the pressurized reservoir such that the coolant remaining at the inside of the ion filter is discharged to the pressurized reservoir.

For example, the ion filter may include a housing having an air inlet port formed at one upper portion thereof, the air inlet port being connected to the other end of the air supply line, a coolant stagnation space formed at an inside thereof, and the coolant outlet port formed at one lower portion thereof and configured to communicate with the coolant stagnation space, an ion exchange resin filling the inside of the housing, and a cap coupled to an upper opening of the housing, the cap having a coolant inlet port formed on an upper surface thereof.

For example, an air flow passage may be formed between an inner surface of the housing and an outer surface of the ion exchange resin.

For example, the pressurized reservoir may have a degassing port formed at one upper portion thereof, the degassing port being connected to one end of the air supply line, a coolant drain port formed at the other upper portion thereof, the coolant drain port being communicatively connected to the coolant outlet port of the ion filter, and a coolant circulation port formed at a lower portion thereof, the coolant circulation port being configured to cause the coolant to circulate toward the second control valve.

For example, a coolant discharge hose may be connected to the coolant outlet port of the ion filter, and a coolant drain pipe communicatively connected to the coolant discharge hose may be connected to the coolant drain port of the pressurized reservoir.

For example, the coolant discharge hose and the coolant drain pipe may be communicatively connected to each other by a joint pipe configured to arrange the coolant discharge hose to be inclined downwards toward the coolant drain pipe.

For example, the air supply line may have a solenoid valve mounted thereon, the solenoid valve being configured to be turned on or off in response to a control signal from the controller so as to permit or block a supply of the air from the pressurized reservoir to the inside of the ion filter.

For example, the controller may be configured to close, when insulation resistance of the fuel cell stack is restored, the first control valve so as to block the coolant from flowing into the ion filter.

For example, when the first control valve is closed, the air inside the pressurized reservoir may be supplied to the inside of the ion filter through the air supply line, and simultaneously, air pressure may be applied to the coolant remaining in the ion filter, thereby draining the coolant from the ion filter to the pressurized reservoir.

The present disclosure provides a coolant drain system of an ion filter, the coolant drain system including a coolant circulation line configured to connect a fuel cell stack, a radiator, and a pump to each other so as to allow coolant to circulate through the fuel cell stack, the radiator, and the pump, a first control valve mounted on the coolant circulation line between a coolant outlet port of the pump and a coolant inlet port of the fuel cell stack, a second control valve mounted on the coolant circulation line between a coolant outlet port of the radiator and a coolant inlet port of the pump, a coolant branch line configured to connect the first control valve, the ion filter, and the second control valve so as to allow the coolant to circulate through the first control valve, the ion filter, and the second control valve, a pressurized reservoir mounted on the coolant branch line between the ion filter and the second control valve, a first air flow connector and a second air flow connector respectively formed on the pressurized reservoir and the ion filter, wherein the first air flow connector and the second air flow connector are connected to each other so as to supply air from the pressurized reservoir to an inside of the ion filter, a first coolant flow connector and a second coolant flow connector respectively formed on the ion filter and the pressurized reservoir, wherein the first coolant flow connector and the second coolant flow connector are connected to each other so as to allow the coolant to flow from the ion filter to the pressurized reservoir, and a controller configured to control an opening/closing direction and an opening degree of each of the first control valve and the second control valve.

For example, the ion filter may include a housing having the second air flow connector formed at one upper portion thereof, a coolant stagnation space formed at an inside thereof, and the first coolant flow connector formed at one lower portion thereof and configured to communicate with the coolant stagnation space, an ion exchange resin filling the inside of the housing, and a cap coupled to an upper opening of the housing, the cap having a coolant inlet port formed on an upper surface thereof.

For example, an air flow passage may be formed between an inner surface of the housing and an outer surface of the ion exchange resin.

For example, the second air flow connector may have bolt fastening grooves respectively formed in opposite ends thereof, and an air inlet hole may be formed between the bolt fastening grooves.

For example, the first coolant flow connector may have bolt fastening holes respectively formed in opposite ends thereof, and a coolant outlet hole may be formed between the bolt fastening holes.

For example, the pressurized reservoir may have the first air flow connector formed at one upper portion thereof and the second coolant flow connector formed at one lower portion thereof.

For example, the first air flow connector may have bolt fastening holes respectively formed in opposite ends thereof, and an air supply hole may be formed between the bolt fastening holes.

For example, the second coolant flow connector may have bolt fastening grooves respectively formed in opposite ends thereof, and a coolant drain hole may be formed between the bolt fastening grooves.

For example, the controller may be configured to close, when insulation resistance of the fuel cell stack is restored, the first control valve so as to block the coolant from flowing into the ion filter.

For example, when the first control valve is closed, the air inside the pressurized reservoir may be supplied to the inside of the ion filter through the first air flow connector and the second air flow connector, and simultaneously, air pressure may be applied to the coolant remaining in the ion filter, thereby draining the coolant from the ion filter to the pressurized reservoir through the first coolant flow connector and the second coolant flow connector.

As is apparent from the above description, the present disclosure provides the following effects.

First, when electrical conductivity of coolant circulating through a fuel cell stack is controlled to be lower than a predetermined level, that is, when insulation resistance of the fuel cell stack is restored, the coolant remaining inside an ion filter may be drained into a pressurized reservoir using the pressure of air supplied from the pressurized reservoir, thereby making it possible not only to maximally reduce direct contact between the coolant and an ion exchange resin, but also to maximally reduce a role of the ion exchange resin as an oxidation catalyst for the coolant. Accordingly, it is possible to prevent deterioration in durability of the ion exchange resin and to reliably improve the lifespan of the ion exchange resin.

Second, it is possible to prevent frequent replacement of the ion exchange resin in the ion filter, thereby reducing maintenance costs.

Although the present disclosure has been described in detail with reference to examples thereof, the scope of the present disclosure is not limited to the above-described examples, and it will be appreciated by those skilled in the art that various modifications and improvements may be made in the examples without departing from the principles and spirit of the disclosure, the scope of which is defined in the appended claims and equivalents thereto.

What is claimed is:

1. A coolant drain system comprising:
a coolant circulation line configured to allow coolant to circulate through a fuel cell stack, a radiator, and a pump;
a first control valve mounted on the coolant circulation line between a coolant outlet port of the pump and a coolant inlet port of the fuel cell stack;
a second control valve mounted on the coolant circulation line between a coolant outlet port of the radiator and a coolant inlet port of the pump;
a coolant branch line configured to allow the coolant to circulate through the first control valve, an ion filter, and the second control valve;
a pressurized reservoir mounted on the coolant branch line between a coolant outlet port of the ion filter and the second control valve;
an air supply line configured to supply air from the pressurized reservoir to an inside of the ion filter; and
a controller configured to control:
a first opening/closing direction of the first control valve; and
a second opening/closing direction of the second control valve.

2. The coolant drain system of claim 1, wherein the ion filter is disposed at a higher position than a position of the pressurized reservoir, such that the coolant inside of the ion filter is discharged to the pressurized reservoir.

3. The coolant drain system of claim 1, wherein the ion filter comprises:
a housing comprising:
an air inlet port formed at an upper portion of the housing and configured to receive air from the air supply line,, and
the coolant outlet port formed at a lower portion of the housing and configured to communicate with a coolant stagnation space formed inside the housing;
an ion exchange resin inside of the housing; and
a cap coupled to an upper opening of the housing, wherein an upper surface of the cap comprises a coolant inlet port.

4. The coolant drain system of claim 3, wherein an air flow passage is formed between an inner surface of the housing and an outer surface of the ion exchange resin.

5. The coolant drain system of claim 1, wherein a first upper portion of the pressurized reservoir comprises a degassing port connected to the air supply line,
wherein a second upper portion of the pressurized reservoir comprises a coolant drain port communicatively connected to the coolant outlet port of the ion filter, and
wherein a lower portion of the pressurized reservoir comprises a coolant circulation port configured to allow the coolant to circulate toward the second control valve.

6. The coolant drain system of claim 5, wherein a coolant discharge hose is connected to the coolant outlet port of the ion filter, and a coolant drain pipe communicatively connected to the coolant discharge hose is connected to the coolant drain port of the pressurized reservoir.

7. The coolant drain system of claim 6, wherein the coolant discharge hose and the coolant drain pipe are communicatively connected to via a joint pipe configured to arrange the coolant discharge hose to be inclined downwards toward the coolant drain pipe.

8. The coolant drain system of claim 1, further comprising a solenoid valve mounted on the air supply line, wherein the solenoid valve is configured to:
be turned on, based on a first control signal from the controller, so as to permit a supply of the air from the pressurized reservoir to the inside of the ion filter; or
be turned off, based on a second control signal from the controller, so as to block a supply of the air from the pressurized reservoir to the inside of the ion filter.

9. The coolant drain system of claim 1, wherein the controller is configured to close, based on electrical conductivity of the coolant satisfying a threshold, the first control valve to block the coolant from flowing to the ion filter.

10. The coolant drain system of claim 9, wherein the controller is further configured to cause, based on the first control valve being closed, the air inside the pressurized reservoir to be supplied via the air supply line to the inside of the ion filter to facilitate draining of the coolant from the ion filter to the pressurized reservoir.

11. A coolant drain system comprising:
a coolant circulation line configured to allow coolant to circulate through a fuel cell stack, a radiator, and a pump;
a first control valve mounted on the coolant circulation line between a coolant outlet port of the pump and a coolant inlet port of the fuel cell stack;
a second control valve mounted on the coolant circulation line between a coolant outlet port of the radiator and a coolant inlet port of the pump;
a coolant branch line configured to allow the coolant to circulate through the first control valve, an ion filter, and the second control valve;
a pressurized reservoir mounted on the coolant branch line between the ion filter and the second control valve;
a first air flow connector formed on the pressurized reservoir;
a second air flow connector formed on the ion filter, wherein the first air flow connector and the second air flow connector are connected to each other to allow the pressurized reservoir to supply air to an inside of the ion filter;
a first coolant flow connector formed on the ion filter;
a second coolant flow connector formed on the pressurized reservoir, wherein the first coolant flow connector and the second coolant flow connector are connected to each other to allow the coolant to flow from the ion filter to the pressurized reservoir; and
a controller configured to control:
a first opening/closing direction ; of the first control valve; and
a second opening/closing direction of the second control valve.

12. The coolant drain system of claim 11, wherein the ion filter comprises:
a housing comprising:
the second air flow connector formed at an upper portion of the housing, and
the first coolant flow connector formed at a lower portion of the housing and configured to communicate with a coolant stagnation space formed inside the housing;
an ion exchange resin inside of the housing; and
a cap coupled to an upper opening of the housing, wherein an upper surface of the cap comprises a coolant inlet port.

13. The coolant drain system of claim 12, wherein an air flow passage is formed between an inner surface of the housing and an outer surface of the ion exchange resin.

14. The coolant drain system of claim 12, wherein bolt fastening grooves are formed on the second air flow connector, and an air inlet hole is formed between the bolt fastening grooves.

15. The coolant drain system of claim 12, wherein bolt fastening holes are formed on the first coolant flow connector, and a coolant outlet hole is formed between the bolt fastening holes.

16. The coolant drain system of claim 11, wherein the first air flow connector is formed at an upper portion of the pressurized reservoir and the second coolant flow connector is formed at a lower portion of the pressurized reservoir.

17. The coolant drain system of claim 16, wherein bolt fastening holes are formed on the first air flow connector, and an air supply hole is formed between the bolt fastening holes.

18. The coolant drain system of claim 16, wherein bolt fastening grooves are formed on the second coolant flow connector, and a coolant drain hole is formed between the bolt fastening grooves.

19. The coolant drain system of claim 11, wherein the controller is configured to:
close, based on electrical conductivity of the coolant satisfying a threshold, the first control valve to block the coolant from flowing to the ion filter,
wherein, when the first control valve is closed, the air inside the pressurized reservoir is supplied, via the first air flow connector and the second air flow connector, to the inside of the ion filter to facilitate draining of the coolant from the ion filter to the pressurized reservoir, and
wherein the electrical conductivity of the coolant is detected via a conductivity sensor.

20. A coolant drain system comprising:
a coolant circulation line configured to allow coolant to circulate to exchange heat with a fuel cell stack, a radiator, and a pump;
a first control valve mounted on the coolant circulation line between the pump and the fuel cell stack;
a second control valve mounted on the coolant circulation line between the radiator and the pump;
a coolant branch line configured to allow the coolant to circulate through the first control valve, an ion filter, and the second control valve;
a pressurized reservoir mounted on the coolant branch line between a coolant outlet port of the ion filter and the second control valve and configured to supply air to an inside of the ion filter;
a conductivity sensor configured to measure a conductivity of the coolant; and
a controller configured to control, based on the conductivity:
the first control valve;
the second control valve; and
supply of air from the pressurized reservoir.
